(19) United States
(12) Patent Application Publication
(10) Pub. No.: US 2007/0012124 A1
(43) Pub. Date: Jan. 18, 2007

(54) Centrifugal propulsion engine

(76) Inventor: Daniel Perez, Pompano Beach, FL (US)

Correspondence Address: Oltman, Flynn & Kubler, Ste #415, 915 Middle River Drive, Fort Lauderdale, FL, 33304, US

(21) Appl. No.: 11/180,273

(22) Filed: Jul. 14, 2005

(51) Int. Cl. F16H 27/04

(52) U.S. Cl. 74/84 S

(57) ABSTRACT

A centrifugal engine includes first and second centrifugal assemblies having independent assembly hub structures, each hub structure being rotatably mounted to a common bearing mount to rotate co-axially and in opposite directions; several spokes protruding radially from each hub structure; a mobile mass structure slidably mounted to each spoke; a rotation motor; several mass structure displacement motors, each for displacing one mobile mass structure along a corresponding spoke; a power source delivering electrical energy to the rotation motor to rotate each hub structure and attached spokes relative to the bearing mount, and also to the mass structure displacement motor to sequentially move the mobile mass structures longitudinally along the spokes and radially away from the given the hub structure and then rapidly toward the hub structure at a repeating rotational position to impart linear force to the assembly.

### BACKGROUND OF THE INVENTION

1. Field of the Invention

The present invention relates generally to the field of devices for converting electrical energy into kinetic energy. More specifically the present invention relates to a centrifugal engine including first and second centrifugal assemblies having independent assembly hub structures, each hub structure being rotatably mounted to a common bearing mount to rotate co-axially and in opposite directions. The bearing mount passes through and is fixedly secured relative to a partition structure such as a satellite wall which extends between and is generally parallel to the first and second centrifugal assemblies. Several spokes protrude radially from each hub structure and a mobile mass structure is slidably mounted to each spoke. A power source delivers electrical energy to rotate each hub structure and attached spokes relative to the bearing mount, and also to sequentially move the mobile mass structures longitudinally along the spokes and radially away from the given hub structure and then rapidly toward the hub structure at a repeating rotational position to impart linear force to the assembly perpendicular to the assembly axis of rotation during mass structure retraction. When the rotational positions of mass structure retraction of the two assemblies coincide, the engine produces a combined linear force in the outward radial direction at the repeating mass structure retraction rotational position. And when the rotational positions of mobile mass structure retraction for the two assemblies are diametrically opposed, the engine produces a torque perpendicular to the axes of rotation of the two assemblies.

Each hub structure includes an assembly axle rotatably and engagingly fitted into the bearing mount. A beveled linking gear engages gear teeth along adjacent beveled edges of the first and second assemblies, constraining them to rotate in opposite directions.

Each spoke includes a spoke rack having an I-beam with a longitudinal series of rack gear teeth along one I-beam edge and includes a rotatable drive rod. Each mobile mass structure includes a carriage which spans the space between and rides along the spoke rack and spoke drive rod. Opposing ends of the bearing mount each have an annular series of gear teeth defining opposing first and second bevel sun gears. Each spoke drive rod of the first or second assembly is secured to and extends radially outward from a bevel planet gear engaging the corresponding first or second bevel sun gear. Each mobile mass structure further includes a drive rod rotation motor secured to its carriage which rotates the drive rod to rotate the attached planet gear to roll around the fixed sun gear and thereby swing the given spoke around the hub. Each mobile mass structure still further includes a mass structure displacement motor secured to the carriage which is slidably mounted to the respective spoke rack and engages rack gear teeth with a worm gear drive mechanism which causes the mass structure to advance either radially outwardly or radially inwardly along the given spoke when activated.

2. Description of the Prior Art

There previously have been engines in which mass is diverted from a gyroscopic path. These devices have been gravity dependent in their operation, which makes them unsuitable for many applications and particularly for use in satellites.

In one prior engine, mass is diverted from a gyroscopic path, or full rotational circle, to stay on one side of a 360 degree range of motion by mechanically swapping weights, from one of several consecutive, rotating arms to the next, and so on, creating an imbalance that appears to create directional movement. In actuality, the device is attempting to find equilibrium as a consequence of gravity, a force that would inevitably cancel out in a zero gravity environment.

In another prior engine, mass is rotated on a hinged arm where, upon its first rotation the mass is redirected at an angle away from its potential gyroscopic plane, once again creating an imbalance and inadvertently transforming gravitational force into directional energy. While this design is counter rotated, it cannot function in zero gravity environments.

It is thus an object of the present invention to provide a centrifugal engine which operates independently of gravity.

It is another object of the present invention to provide such an engine which manipulates mass relative to the mass position within a rotation radially relative to the axis of rotation to perpetuate rotational motion.

It is still another object of the present invention to provide such an engine which can be designed to generate a desired magnitude of directional rotational power by providing a selectable number of spokes and mobile weight structures each having a selected mass.

It is finally an object of the present invention to provide such an engine which is sturdy, reliable and relatively inexpensive to manufacture.

### SUMMARY OF THE INVENTION

The present invention accomplishes the above-stated objectives, as well as others, as may be determined by a fair reading and interpretation of the entire specification.

A centrifugal engine, including first and second centrifugal assemblies having independent assembly hub structures, each hub structure being rotatably mounted to a common bearing mount to rotate co-axially and in opposite directions; several spokes protruding radially from each hub structure; a mobile mass structure slidably mounted to each spoke; at least one rotation motor; several mass structure displacement motors, each for displacing one mobile mass structure along a corresponding spoke; a power source delivering electrical energy to the at least one rotation motor to rotate each hub structure and attached spokes relative to the bearing mount, and also to the mass structure displacement motor to sequentially move the mobile mass structures longitudinally along the spokes and radially away from the given hub structure and then rapidly toward the hub structure at a repeating rotational position to impart linear force to the assembly perpendicular to the assembly axis of rotation during mass structure retraction.

Each of the hub structures preferably include an assembly axle rotatably and engagingly fitted into the bearing mount. The centrifugal engine preferably additionally includes gear teeth along adjacent beveled edges of the first and second hub structures and a beveled linking gear engaging gear teeth along adjacent beveled edges of the first and second hub structures, constraining the first and second centrifugal assemblies to rotate in opposite directions. Each spoke preferably includes a spoke rack having an I-beam with a longitudinal series of rack gear teeth along one I-beam edge, and a rotatable drive rod substantially parallel and adjacent to the I-beam, and each mobile mass structure preferably includes a carriage which extends between and rides along the spoke rack and the spoke drive rod opposing ends of the bearing mount each have an annular series of gear teeth defining opposing first and second bevel sun gears, and each spoke drive rod of each of the first and second assemblies is secured to and extends radially outward from a bevel planet gear engaging the corresponding one of the first and second bevel sun gear.

Each drive rod rotation motor is secured to its carriage which rotates the drive rod to rotate the attached planet gear, causing the attached planet gear to roll around the fixed sun gear and thereby swing the given spoke around the hub.

Each mass structure displacement motor preferably is secured to the corresponding carriage which is slidably mounted to the respective spoke rack and engages the rack gear teeth with a worm gear drive mechanism, causing the mass structure to advance one of radially outwardly and radially inwardly along the given spoke when activated. The centrifugal engine preferably additionally includes an outer rim structurally interconnecting the spokes of each assembly.

The centrifugal engine preferably additionally includes several motor wires, where each drive rod rotation motor and mass displacement motor receives power through a corresponding motor wire, and where motor wires are connected to a switching relay which delivers electricity to each drive rod rotation motor and mass displacement motor at periodic intervals and for durations necessary to maintain assembly displacement.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a concept drawing of the outward face of the centrifugal drive assembly A of the centrifugal propulsion engine spinning in a clockwise direction of rotation illustrating the necessary position of each mobile mass structure during one cycle to create impulse in a northerly direction.

FIG. 2 is a concept drawing of the outward face of the centrifugal drive assembly B of the centrifugal propulsion engine spinning in a counter-clockwise direction of rotation illustrating the necessary position of each mobile mass structure during one cycle to create impulse in a northerly direction showing mobile mass structure positions directly corresponding to those shown in FIG. 1.

FIG. 3 is a broken away perspective view of the preferred bearing mount and hub structures of the present engine, showing rows of exposed ball bearings arrayed within annular bearing races to minimize friction and absorb loading of hub structures rotating relative to the bearing mount.

FIG. 3a is a full perspective view of the engine as shown in FIG. 3.

FIG. 4 is a side view of a single mass structure, including the drive rod rotation motor and mass structure displacement motor, worm gear and of a segment of a spoke along which it is riding, including a carriage bracket interconnecting the two motors.

FIG. 5 is an end view of the mobile mass structure of FIG. 4, with the spoke elements shown in cross-section.

FIG. 6 is a broken away close-up view of a drive rod slide structure encircling a drive rod and having slide structure connection struts, the slide structure including four internal guide wheels bearing against four sides of the square cross-section drive rod, placed within its structural environment within the engine.

FIG. 7 is a cross-sectional end view of the drive rod slide structure of FIG. 6.

FIG. 8 is a side view of the drive rod slide structure of FIG. 7.

FIG. 9 is a schematic wiring diagram of the preferred embodiment of the present engine.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

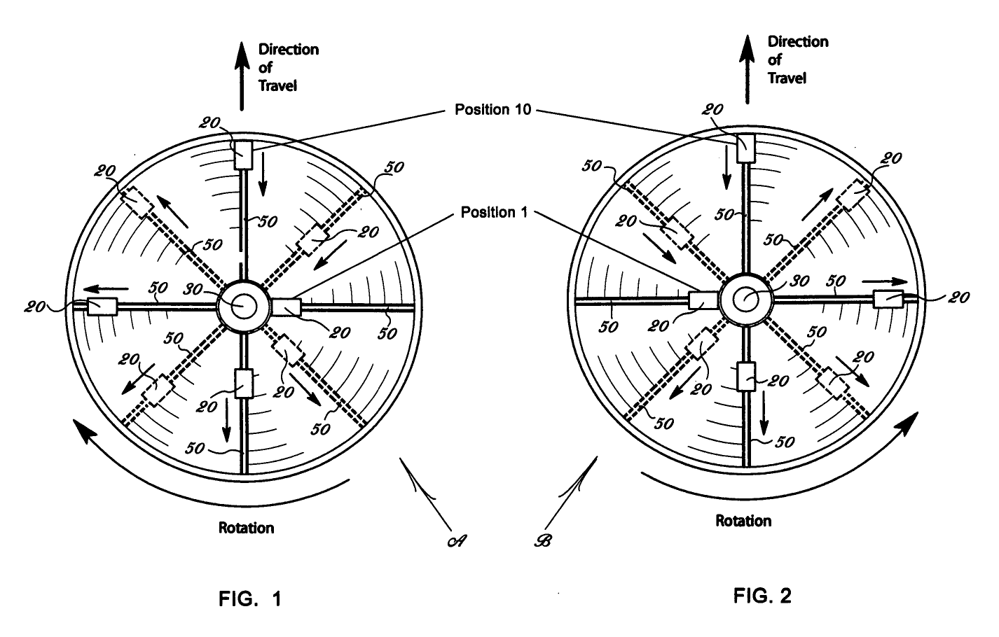

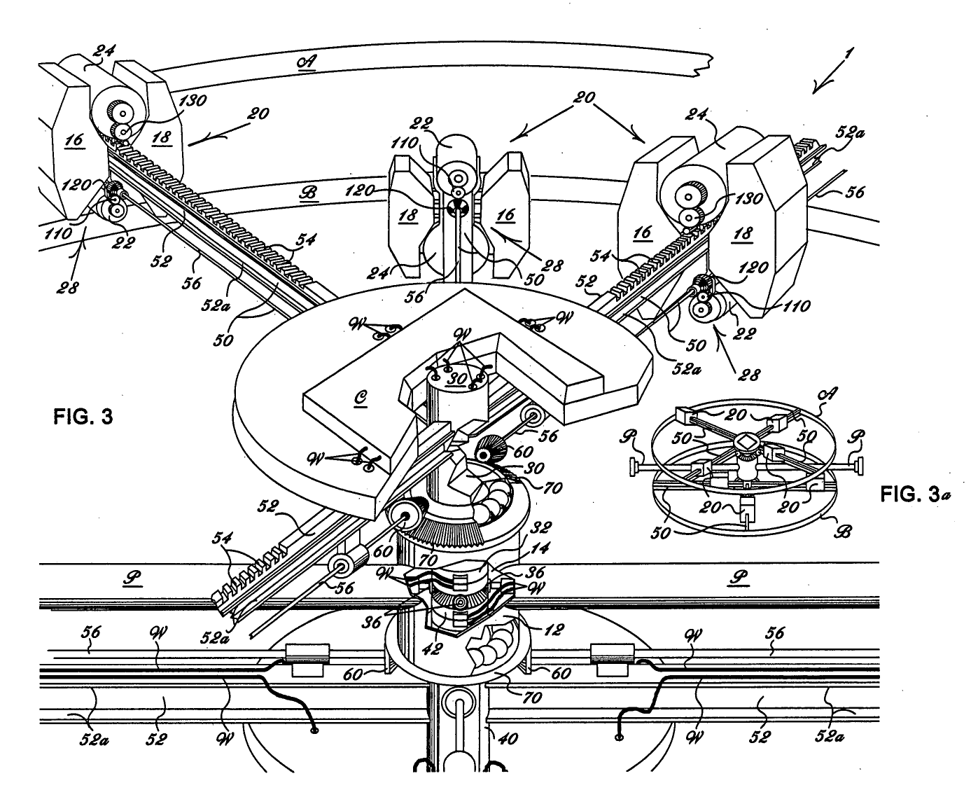

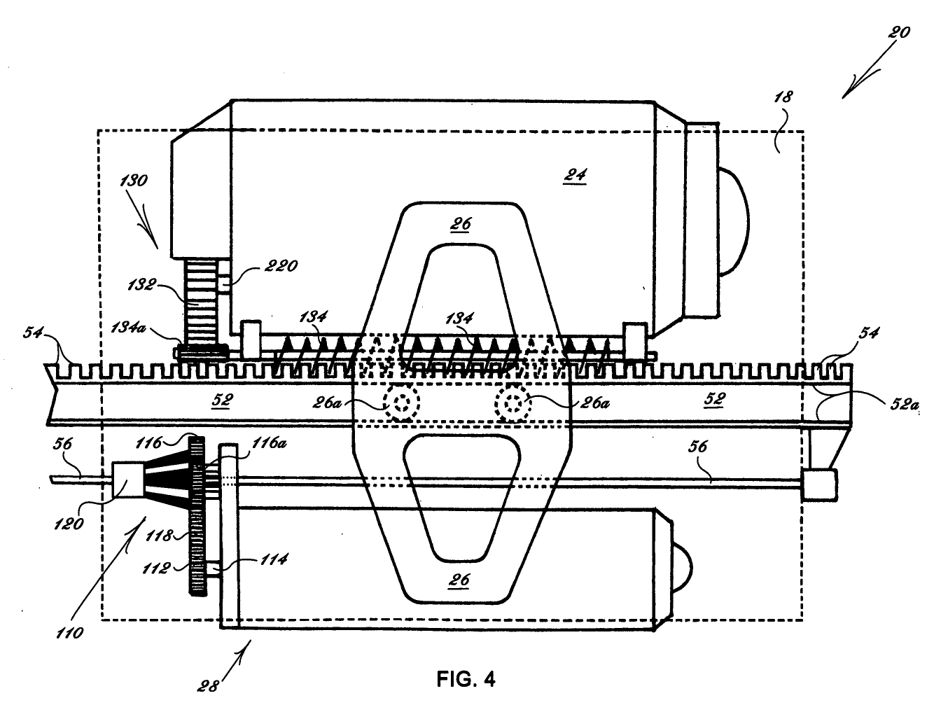

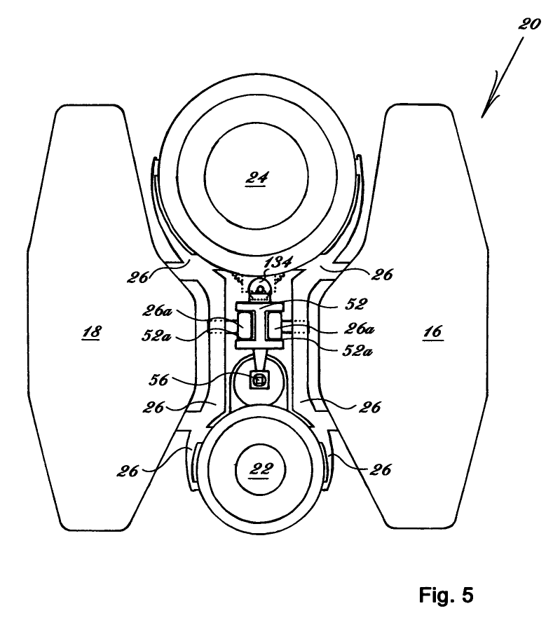

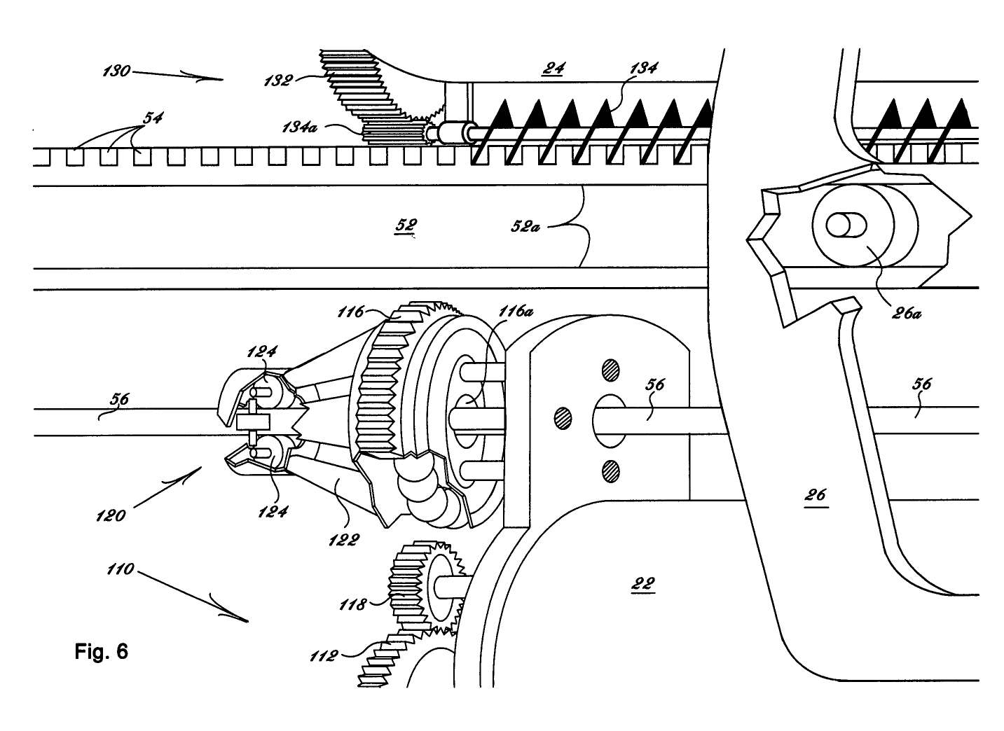

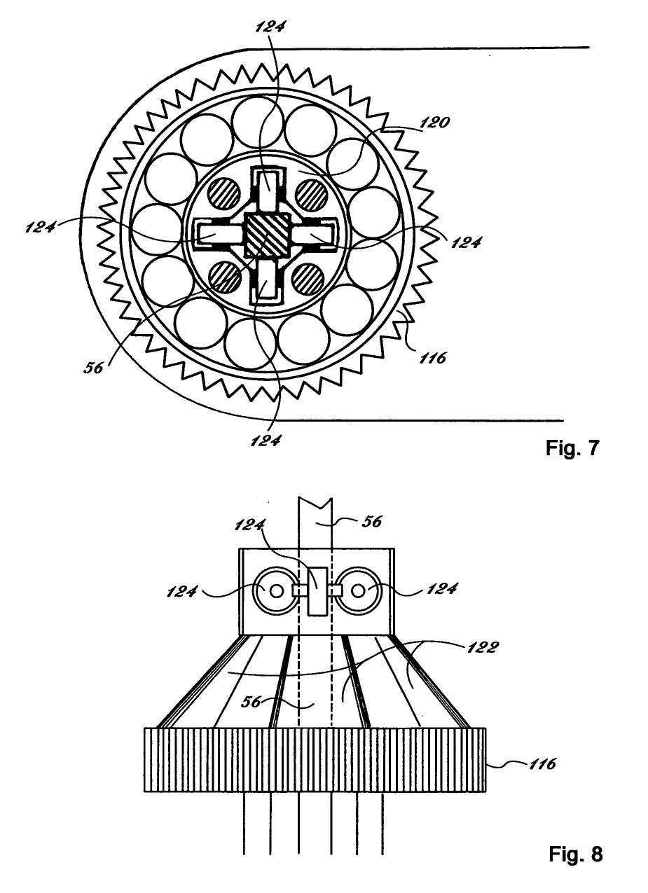

Referring to FIGS. 1-9, a centrifugal engine 10 is disclosed including first and second centrifugal assemblies A and B, respectively, having independent first and second assembly hub structures 30 and 40, each hub structure 30 and 40 being rotatably mounted to a common bearing mount 12 to rotate co-axially and in opposite directions. The bearing mount 12 passes through and is fixedly secured relative to a partition structure P such as a satellite wall which extends between and is generally parallel to the first and second centrifugal assemblies A and B. Several spokes 50 protrude radially from each hub structure 30 and 40 and a mobile mass structure 20 is slidably mounted to each spoke 50. A power source preferably in the form of battery packs 16 and 18 delivers electrical energy to rotate each hub structure 30 and 40 and attached spokes 50 relative to the bearing mount 12, and also to sequentially move the mobile mass structures 20 longitudinally along the spokes 50 and radially away from the given hub structure 30 or 40 and then rapidly toward the hub structure 30 or 40 at a repeating rotational position to impart linear force to the assembly A or B perpendicular to the assembly axis of rotation AR during mobile mass structure 20 retraction. When the rotational positions of mass structure 20 retraction of the two assemblies A and B coincide, the engine 10 produces a combined linear force in the outward radial direction at the repeating mass structure 20 retraction rotational position. And when the rotational positions of mobile mass structure 20 retraction for the two assemblies A and B are diametrically opposed, the engine 10 produces a torque perpendicular to the axes of rotation of the two assemblies A and B.

Each hub structure 30 and 40 includes a respective assembly axle 32 and 42 rotatably and engagingly fitted into opposing ends of an axial bearing mount passageway 14 in the bearing mount 12. At least one and preferably three beveled linking gear 36 engages hub directional gears defined by a series of gear teeth along adjacent beveled edges of the first and second assembly axles 32 and 42, constraining them to rotate in opposite directions.

Each spoke includes spoke rack 52 in the form of an I-beam with a longitudinal series of rack gear teeth 54 along one I-beam edge and includes a rotatable drive rod 56. Each mobile mass structure 20 includes a motor carriage 26 which spans the space between and rides along the spoke rack 52 and spoke drive rod 56. Each spoke drive rod 56 is secured to and extends radially outward from a bevel planet gear 60 engaging the corresponding bevel sun gear 70. Each mobile mass structure 20 further includes rotational drive mechanism 28 having a drive rod rotation motor 22 secured to its carriage 26 which rotates the drive rod 56 to rotate the attached planet gear 60 to roll around the sun gear 70 and thereby swing the given spoke 50 around its hub structure 40.

The rod rotation motor 22 is drivably connected to a rod rotation motor gear train 110 including a rod rotation motor gear 112 connected to the rod rotation motor drive shaft 114, a rod rotation gear 116 and a rotation reversal gear 118 meshing with and drivably interconnecting the rod rotation motor gear 112 and the rod rotation gear 116 rotatably and slidably connected to the corresponding drive rod 56. The rod rotation gear 116 preferably has a gear central port 116a through which the drive rod 56 slidably passes and is connected to a drive rod slide structure 120 encircling the drive rod 56 with slide structure connection struts 122. The slide structure 120 includes four guide wheels 124 bearing against four sides of the drive rod 56. Guide wheels 124 permit the slide structure 120 to ride freely along the length of the drive rod 56 and yet to engage the drive rod 56 so that the drive rod 56 is constrained to rotate in unison with the slide structure 120 and the rod rotation gear 116.

Each mobile mass structure 20 still further includes a mass structure displacement motor 24 secured to the carriage 26 which is slidably mounted to the respective spoke rack 52 and engages rack gear teeth 54 with a worm gear drive mechanism 58 which causes the mass structure 20 to advance either radially outwardly or radially inwardly along the given spoke 50 when activated. A displacement motor gear train 130 includes displacement motor gear 132 mounted to the drive rod rotation displacement motor drive shaft 220 and a worm gear pinion 134a mounted to an end of worm gear 134 so that the worm gear pinion 134a and the worm gear 134 rotate co-axially and the worm gear pinion 134 meshes with the displacement motor gear 132. The motor carriage 26 preferably includes a pair of mutually parallel and spaced apart carriage brackets interconnecting motors 22 and 24, battery packs 16 and 18 and first and second pairs of carriage wheels 26a extending into the opposing channels of the given I-beam rack 52a. Opposing ends of the bearing mount 12 each have an annular series of gear teeth defining opposing first and second bevel sun gears 70.

Motors 22 and 24 themselves along with battery packs 16 and 18 may provide the necessary mass for the mobile mass structure 20, or an additional passive mass may be connected to increase the composite mass of the mobile mass structure 20. Each mass structure motor 22 and 24 receives power through a corresponding motor wire W, and the motor wires W are all connected to a switching relay in the form of a control chip C which delivers electricity to each mass structure motor 22 and 24 at periodic intervals and for durations necessary to maintain assembly A and B functions. A pair of battery packs 16 and 18 preferably are connected to each motor wire W and to motors 22 and 24 of each mobile mass structure 20. Battery packs 16 and 18 are the primary power source. The secondary power source is optionally a solar panel 140 secured to the exterior of the engine 10 or to a structure outside engine 10 to provide power for recharging the battery packs 16 and 18.

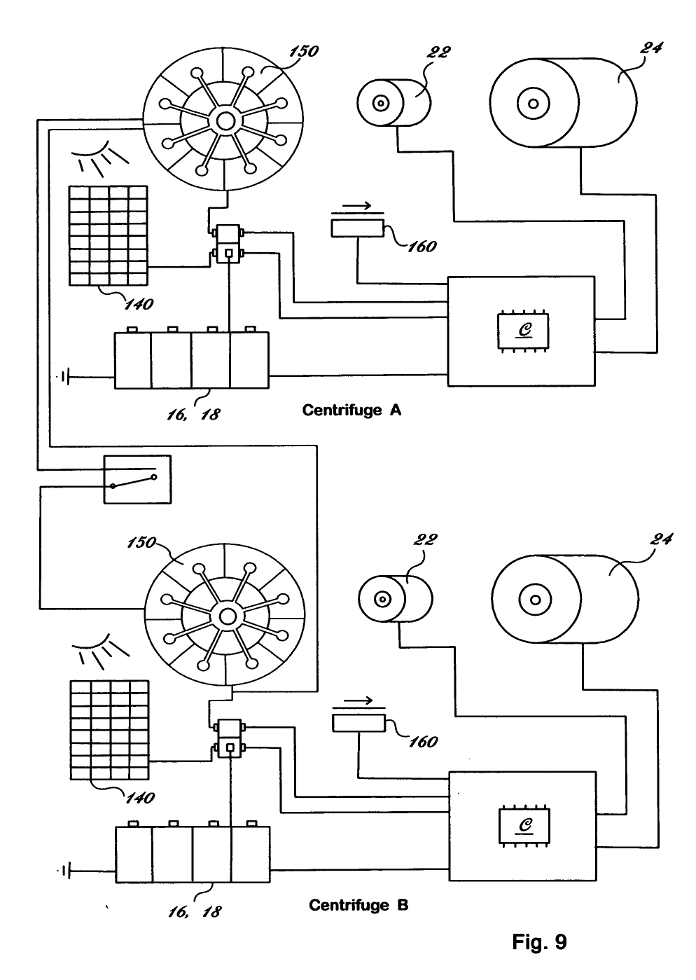

Additional features of engine 10 include a joy stick 150 for operating and controlling activation, deactivation, speed, rotation and force produced by each centrifugal assembly A and B of engine 10 individually. See FIG. 9.

A magnetic sensor 160 communicates real time information to a control chip C concerning the location of each mobile mass structure 20 within its stroke along the corresponding spoke 50. The control chip C provides a back-up diagnostic function. Two controls are provided for omni-directional engine 10 movement. For omnidirectional movement along the same plane, only one joy stick 150 is needed.

### Method

In practicing the invention, the following method may be used. To create directional impulsion by the centrifugal propulsion engine 10, the engine 10 first begins rotating with all mobile mass structures 20 in the neutral position; this is where all of the mobile mass structures 20 are at position 1. See FIGS. 1 and 2.

It is worth noting that the speed, or RPMs at which centrifugal assembly A moves is always equal and mechanically linked to the speed at which assembly B moves. Once the engine's RPMs are at the desired rate and a gyroscopic plane has been achieved, the engine 10 is standing by for a direction in which to move; all mobile mass structures 20 are still at position 1.

Whereas the centrifugal propulsion engine 10 is capable of omni-directional movement, for purposes of instruction, North will be designated the twelve O-clock direction of travel as seen from above on a horizontal plane with the engine 10 mounted on a free moving platform. This engine 10 will be equipped with four linear motion spokes 50 on each centrifugal assembly A and B making it an eight-piston single stroke engine 10. Centrifugal assembly A will be mounted over assembly B and spins clockwise. Numerical values equivalent to the face of a clock will also be given to the potential motion of both assemblies A and B.

With the engine 10 at the desired rate of RPM's and all mobile mass structures 20 waiting at position 1, the engine 10 is directed to move forward towards the twelve O'clock direction of travel, once spoke 1A is at the three O'clock positions spoke 1A is signaled to begin a controlled movement out from position 1 towards position two, three, and so on; reaching position 10 by 11 o'clock, position 10 being the outermost position on the end of its spoke 50. When spoke 1A reaches the 12 o'clock position it is signaled to move in from position 10 to position 1. This inward motion is fully accomplished by the time spoke 1A reaches the 3 o'clock position. By the time spoke 1A crosses the three O'clock position, spoke 2A, of assembly A's four spokes, is crossing over the twelve O'clock position. When spoke 1A reaches the six O'clock position, its mobile mass structure 20 will be at position 4 of its slower outward journey, while spoke 2A is just beginning its movement out of position 1 at the three O'clock position. When spoke 1A reaches the eleven O'clock position, its mobile mass structure 20 will have reached position 10 at the end of spoke 1A. At this point, mobile mass structure 20 of spoke 1A remains at position ten until it crosses over the twelve O'clock position where it then begins its journey back to position 1. Meanwhile, each of the three remaining spokes 2A-4A are performing the same functions consecutively. By the time spoke 1A is once again at the three O'clock position, its mobile mass structure 20 is once again at position 1, having completed its stroke, and is ready to perform another cycle.

As both assemblies A and B are mechanically linked by assembly axles 32 and 42 to counter-rotate, when a mobile mass structure 20 within assembly A is directed to begin a stroke at the mechanism's three O'clock position, with twelve O'clock being the direction or position of travel, a mobile mass structure 20 on assembly B must always begin a matching stroke at the nine O'clock position, opposite to three O'clock, effectively balancing the engine 10.

When travel in the six O'clock position is desired, the centrifugal assembly A is simply timed to begin its strokes at the nine O'clock position where centrifugal assembly B naturally starts at the three O'clock position. This inherent ability to rapidly change positions is also an exceptional means of deceleration.

All gyroscopes have a central pivot point. The centrifugal propulsion engine 10 is in essence two, counter-rotating gyroscopes connected along their central pivot points. By directing centrifugal assembly A's mobile mass structures 20 to create impulsion in one direction and centrifugal assembly B's mobile mass structures 20 to create impulsion in the opposite direction, the engine as a whole, and any vehicle it is powering, move along its newly created central pivot point directly between the two previous pivot points, changing the gyroscopic plane of the mechanism in any direction imagined, permitting omni-directional movement.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A centrifugal engine, comprising:
first and second centrifugal assemblies having independent assembly hub structures, each said hub structure being rotatably mounted to a common bearing mount to rotate co-axially and in opposite directions;
a plurality of spokes protruding radially from each said hub structure;
a mobile mass structure slidably mounted to each said spoke;
at least one rotation motor means;
a plurality of mass structure displacement motor means, each for displacing one said mobile mass structure along a corresponding said spoke;
a power source delivering electrical energy to said at least one rotation motor means to rotate each hub structure and attached spokes relative to the bearing mount, and also to said mass structure displacement motor means to sequentially move said mobile mass structures longitudinally along said spokes and radially away from the given said hub structure and then rapidly toward said hub structure at a repeating rotational position to impart linear force to the assembly perpendicular to the assembly axis of rotation during mass structure retraction;
and electronic control means connected to said mass structure displacement motor means controlling the engine speed and duration.

2. The centrifugal engine of claim 1, wherein each said hub structure comprises an assembly axle rotatably and engagingly fitted into said bearing mount.

3. The centrifugal engine of claim 1, additionally comprising gear teeth along adjacent beveled edges of said first and second hub structures and a beveled linking gear engaging gear teeth along adjacent beveled edges of said first and second hub structures, constraining said first and second centrifugal assemblies to rotate in opposite directions.

4. The centrifugal engine of claim 1, wherein each said spoke comprises a spoke rack having an I-beam with a longitudinal series of rack gear teeth along one I-beam edge, and a rotatable drive rod substantially parallel and adjacent to said I-beam, and wherein each said mobile mass structure comprises a carriage which extends between and rides along said spoke rack and said spoke drive rod.

5. The centrifugal engine of claim 4, wherein opposing ends of said bearing mount each have an annular series of gear teeth defining opposing first and second bevel sun gears, and each said spoke drive rod of each of said first and second assemblies is secured to and extends radially outward from a bevel planet gear engaging the corresponding one of said first and second bevel sun gear.

6. The centrifugal engine of claim 5, wherein each said rotation motor means comprises a drive rod rotation motor secured to its carriage which rotates the drive rod to rotate the attached said planet gear, causing the attached said planet gear to roll around the fixed said sun gear and thereby swing the given said spoke around the hub.

7. The centrifugal engine of claim 5, wherein each said mass structure displacement motor means is secured to the corresponding said carriage which is slidably mounted to the respective said spoke rack and engages said rack gear teeth with a worm gear drive mechanism, causing said mass structure to advance one of radially outwardly and radially inwardly along the given said spoke when activated.

8. The centrifugal engine of claim 1, additionally comprising an outer rim structurally interconnecting said spokes of each said assembly.

9. The centrifugal engine of claim 3, additionally comprising a plurality of motor wires, wherein each said drive rod rotation motor means and said mass structure displacement motor means receive power through a corresponding said motor wire, and wherein said motor wires are connected to a switching relay which delivers electricity to each said drive rod rotation motor means at periodic intervals and for durations necessary to maintain assembly displacement.

10. A centrifugal engine, comprising:
a centrifugal assembly comprising an engine axle and a hub fixedly mounted on said engine axle and a plurality of spokes extending radial from said hub;
and a mobile mass structure slidably mounted on each said spoke protruding from said hub and a mass structure motor for moving each said mobile mass structure radially along said spokes toward and away from said engine axle.
